(19) United States
(12) Patent Application Publication
(10) Pub. No.: US 2010/0182304 A1
(43) Pub. Date: Jul. 22, 2010

(54) MATRIX DISPLAY DEVICE

(75) Inventors: Hiroyuki NITTA, Fujisawa (JP); Masanori TAKEUCHI, Tokyo (JP)

Correspondence Address: MATTINGLY & MALUR, P.C., 1800 DIAGONAL ROAD, SUITE 370, ALEXANDRIA, VA, 22314, US

(73) Assignee: HITACHI CONSUMER ELECTRONICS CO., LTD., Tokyo (JP)

(21) Appl. No.: 12/690,435

(22) Filed: Jan. 20, 2010

(30) Foreign Application Priority Data
Jan. 22, 2009 (JP) 2009-011515

(51) Int. Cl. G09G 5/00

(52) U.S. Cl. 345/211

(57) ABSTRACT

A matrix display device has first and second discharge sustaining electrode drive circuits that perform power recovery for the capacitance load through an LC resonance circuit using an inductor. During a luminescence emission period, a discharge is effected for display by applying an alternating voltage between each of plural first discharge sustaining electrodes and each of plural second discharge sustaining electrodes with a capacitance load corresponding to each display pixel. In the address scanning operation, the scan drive circuit selects the first discharge sustaining electrode per line, and in the discharge sustaining operation, the scan drive circuit provides a function for recovering power on the first discharge sustaining electrode. This is intended to decrease loss in the power recovery operation.

### CLAIM OF PRIORITY

The present application claims priority from Japanese patent application JP 2009-011515 filed on Jan. 22, 2009, the content of which is hereby incorporated by reference into this application.

### BACKGROUND OF THE INVENTION

(1) Field of the Invention

The present invention relates generally to matrix display devices, and more particularly, though not exclusively, to a device using a plasma display panel (PDP).

(2) Description of the Related Art

Flat panel display (FPD) devices using a plasma display panel (PDP), for example, included in the category of matrix display devices are particularly advantageous in that slim-profile large-sized screen structures can be achieved at low cost. In the flat display device marketplace, plasma display panel devices are considerably prevalent at present, rivaling liquid crystal display devices. Recent years have seen an increasing demand for flat display devices featuring lower power consumption as well as larger screen sizes and higher definition/resolution for enhancement in image quality. The luminescence mechanisms of a plasma display panel are as follows; a high voltage is applied to a gas sealed in the panel to produce a discharge, which emits ultraviolet light to excite phosphors in the panel, thereby giving off visible light. For controlling luminescence emission of the plasma display panel, a voltage signal as high as 100-odd volts is used in drive circuitry thereof. Since the plasma display panel is so structured that dielectric materials and gas are sandwiched between electrodes, a significant capacitance load is involved in operation thereof. On account of this capacitance load in the plasma display panel, a power loss in application of the high voltage signal causes a bottleneck in accomplishment of lower power consumption.

Japanese Patent Application Laid-Open Publication No. 2007-57737 discloses an arrangement intended for reduction in power loss associated with charging/discharging of the capacitance load mentioned above. In this arrangement based on power recovery operation for recovering power charged in the capacitance load and reusing the recovered power at the time of recharging the capacitance load, there is provided a technique for reducing power loss by decreasing the number of switches on a power recovery current path in a power recovery circuit. More specifically, when a potential on a discharge path is higher than a level of a constant voltage power supply, a connection between a switching element of the power recovery circuit and the constant voltage power supply is set up via a diode to feed a current from the discharge path to the constant voltage power supply, and when the potential on the discharge path is lower than the level of the constant voltage power supply, a connection between a diode of the power recovery circuit and the constant voltage power supply is set up via a diode and switching element to feed a current from the constant voltage power supply to the discharge path. Thus, the number of switches on the power recovery current path is decreased.

### SUMMARY OF THE INVENTION

In the disclosure of the above-mentioned patent document, although the number of switches related to the discharge path is decreased, no consideration is given to a loss due to a switch of a scan driver IC connected in series with the power recovery path. The scan driver IC is so arranged that a low-voltage selection switch thereof turns on at the time of discharge sustaining driving operation, causing a resistance-induced loss factor (resistance component load) on the power recovery path.

It is therefore an object of the present invention to provide an arrangement for decreasing loss in power recovery operation in a matrix display device.

In accomplishing this object of the present invention and according to one aspect thereof, there is provided a matrix display device in which plural address electrodes are driven per line by a scan drive circuit to control a display state of each display pixel on the basis of display data, and in which, during a luminescence emission period, a discharge is effected for display by applying an alternating voltage between each of plural first discharge sustaining electrodes and each of plural second discharge sustaining electrodes with a capacitance load corresponding to each display pixel, the matrix display device being arranged to include a first discharge sustaining electrode drive circuit; and a second discharge sustaining electrode drive circuit; wherein, in electrode driving operation for driving the first discharge sustaining electrode and the second discharge sustaining electrode with the alternating voltage, the first discharge sustaining electrode drive circuit and the second discharge sustaining electrode drive circuit perform power recovery for the capacitance load through an LC resonance circuit using an inductor, and wherein, in address scanning operation, the scan drive circuit selects the first discharge sustaining electrode per line, and in discharge sustaining operation, the scan drive circuit serves to provide a function of the first discharge sustaining electrode drive circuit for recovering power on the first discharge sustaining electrode.

Further, according to another aspect of the present invention, the scan drive circuit includes a high-voltage output switch circuit and a low-voltage output switch circuit; wherein, in address scanning operation, the high-voltage output switch circuit applies a high voltage for non-selection to a non-selected line, and the low-voltage output switch circuit applies a low voltage for selection to a selected line, and wherein, in discharge sustaining operation, the high-voltage output switch circuit performs a clamp-up operation for power recovery, and the low-voltage output switch circuit performs a recovery switching operation for power recovery.

As described above and according to the present invention, the scan driver IC is used in common for address scanning operation and for clamp-up/power recovery operation, i.e., the scan driver IC serves to provide an address scanning function at the time of address scanning, and also serves to provide a clamp-up/power recovery function on the discharge sustaining electrode at the time of discharge sustaining driving. Thus, the discharge sustaining circuit can be simplified, and the number of switches on the power recovery path can be decreased for reduction in resistance-induced loss. In accordance with the present invention, it is therefore possible to reduce power consumption in a plasma display device and to decrease the number of component parts for achieving lower cost of production thereof.

The above and other objects, features and advantages of the present invention will become more apparent from the following detailed description with reference to the accompanying drawings.

### BRIEF DESCRIPTION OF THE DRAWINGS

FIG. 1 is a circuit diagram showing a component arrangement of a power recovery circuit according to a first preferred embodiment of the present invention;

FIG. 2 is a block diagram showing a schematic overall configuration of drive circuitry of a plasma display device according to the first preferred embodiment of the present invention;

FIG. 3 is a timing chart showing drive waveforms in the power recovery circuit according to the first preferred embodiment of the present invention;

FIG. 4 is a circuit diagram showing a component arrangement of a power recovery circuit in accordance with a conventional technique;

FIG. 5 is a circuit diagram showing a component arrangement of a power recovery circuit according to a second preferred embodiment of the present invention;

FIG. 6 is a timing chart showing drive waveforms in the power recovery circuit according to the second preferred embodiment of the present invention;

FIG. 7 is a block diagram showing a schematic overall configuration of drive circuitry of a plasma display device according to a third preferred embodiment of the present invention;

FIG. 8 is a circuit diagram showing a component arrangement of the power recovery circuit according to the third preferred embodiment of the present invention; and

FIG. 9 is a timing chart showing drive waveforms in the power recovery circuit according to the third preferred embodiment of the present invention.

### DETAILED DESCRIPTION OF THE PREFERRED EMBODIMENTS

The present invention will now be described in detail by way of example with reference to the accompanying drawings showing illustrative embodiments thereof in application to plasma display devices.

### First Embodiment

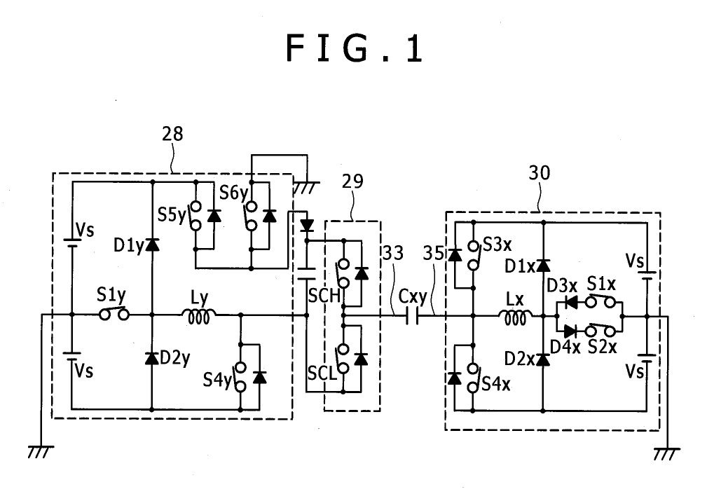

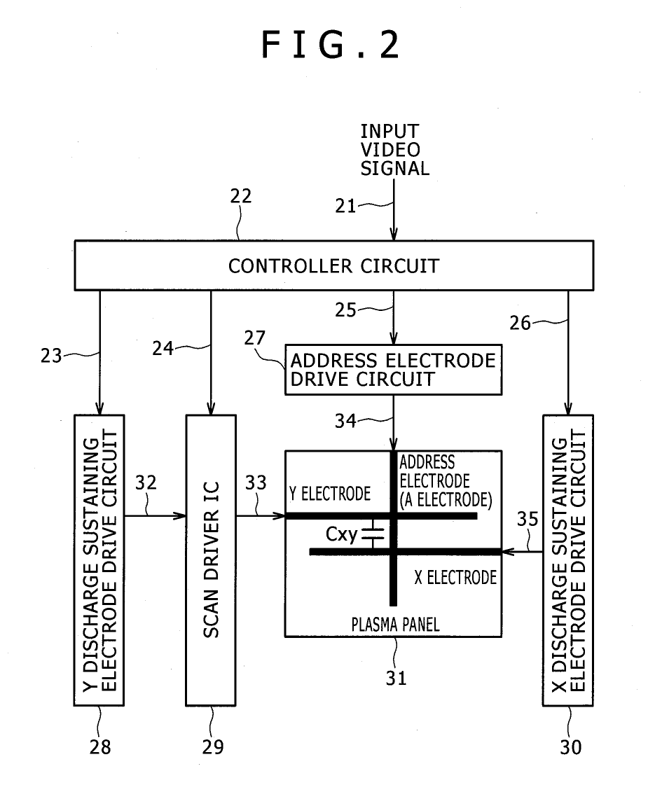

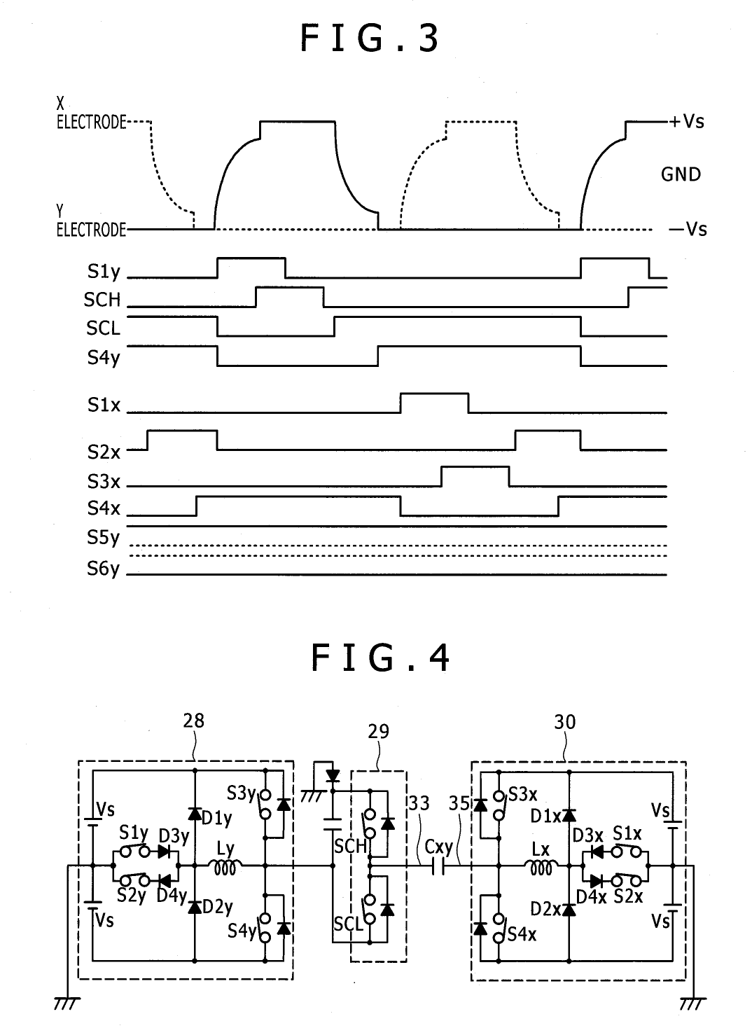

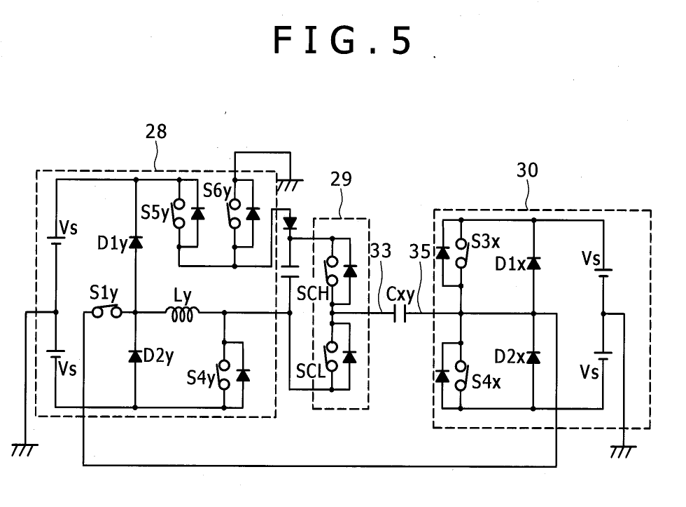

Referring to FIGS. 1 to 4, a first preferred embodiment of the present invention is described below. FIG. 1 shows a component arrangement of a power recovery circuit/discharge sustaining electrode drive circuit of a plasma display device, FIG. 2 shows a schematic overall configuration of drive circuitry of the plasma display device, FIG. 3 shows drive voltage waveforms in power recovery operation and discharge sustaining operation in a timing sequence of control signals of the drive circuitry thereof, and FIG. 4 shows a component arrangement of a power recovery circuit/discharge sustaining electrode drive circuit in accordance with a conventional technique.

In FIG. 2, reference numeral 21 indicates an input video signal to the plasma display device, reference numeral 22 indicates a controller circuit, reference numeral 27 indicates an address electrode drive circuit, reference numeral 28 indicates a Y discharge sustaining electrode drive circuit, reference numeral 29 indicates a scan driver IC, reference numeral 30 indicates an X discharge sustaining electrode drive circuit, and reference numeral 31 indicates a plasma panel. Reference numeral 23 indicates a control signal to the Y discharge sustaining electrode drive circuit 28, reference numeral 24 indicates a control signal to the scan driver IC 29, reference numeral 25 indicates a control signal to the address electrode drive circuit 27, and reference numeral 26 indicates a control signal to the X discharge sustaining electrode drive circuit 30. Reference numeral 32 indicates a drive voltage output from the Y discharge sustaining electrode drive circuit 28 to the scan driver IC 29. Reference numeral 33 indicates a drive voltage output from the scan driver IC 29 for driving a Y electrode of the plasma panel 31. Reference numeral 35 indicates a drive voltage output from the X discharge sustaining electrode drive circuit 30 for driving an X electrode of the plasma panel 31. Reference numeral 34 indicates a drive voltage output from the address electrode drive circuit 27 for driving an address electrode (A electrode) of the plasma panel 31. It is to be noted that, although the plasma panel 31 includes plural Y electrodes, plural X electrodes, and plural address electrodes (A electrodes) arranged in a matrix display form based on the number of pixels, a simplified schematic illustration thereof is shown in FIG. 2 for the sake of clarity and convenience in explanation.

The following describes the drive operation of the plasma panel 31. In the plasma panel drive operation, there are provided an address drive period during which a pre-discharge is effected at a pixel to be displayed, and a discharge sustaining period during which a discharge is effected to display the pixel that has been pre-discharged during the address drive period. During the address drive period, the controller circuit 22 receives an input video signal 21 for addressing. Then, to the address electrode drive circuit 27, the controller circuit 22 transfers address data indicating whether or not to display each pixel per line. Upon receiving the address data transferred from the controller circuit 22, the address electrode drive circuit 27 drives an address electrode (A electrode) per line by applying a drive voltage 34 thereto. In synchronization therewith, the scan driver IC 29 outputs a drive voltage 33 to a Y electrode as a line selection voltage. On a line thus selected, a pre-discharge is effected. The address electrode drive circuit 2 and the scan driver IC 29 repeat the above steps of operation in synchronization with each other in such a successive manner as to carry out the pre-discharging of all the lines. For example, in a case where the plasma panel 31 has a vertical resolution of 1080 lines, while the scan driver IC 29 performs scanning from line 1 to line 1080 in succession, the address electrode drive circuit 27 outputs drive voltages 34 corresponding to address data of respective lines in synchronization with the scanning by the scan driver IC 29. During the discharge sustaining period, each of Y and X electrodes is driven at a pixel that has been pre-discharged during the address drive period. Thus, a discharge is sustained for pixel display between the Y and X electrodes. To produce an alternating voltage of 2Vs between the Y and X electrodes, +Vs voltage is applied to the Y electrode and −Vs voltage is applied to the X electrode, and then −Vs voltage is applied to the Y electrode and +Vs voltage is applied to the X electrode in an alternating fashion of operation. The Y discharge sustaining electrode drive circuit 28 and the X discharge sustaining electrode drive circuit 30 receive control signals 23 and 26 from the controller circuit 22, respectively, to produce +Vs and −Vs voltages for alternating drive operation. The X electrode is driven by a drive voltage 35 output from the X discharge sustaining electrode drive circuit 30. A drive voltage 32 output from the Y discharge sustaining electrode drive voltage 28 is fed to the scan driver IC 29 to output a drive voltage 33 to the Y electrode. Thus, the Y electrode is driven by the drive voltage 33. During the discharge sustaining period, the Y and X electrodes are alternately driven as mentioned above to sustain a discharge for pixel display therebetween with a flow of a discharge sustaining current. In addition, a charge-discharge current is made to flow for charging/discharging a capacitor Cxy. Therefore, for reduction in power required for charging/discharging during the discharge sustaining period, a power recovery circuit using an LC resonance circuit is provided to perform power recovery operation. The power recovery operation thus performed can contribute to a decrease in power consumption.

The following describes the details of drive circuit operation to be performed during the discharge sustaining period in accordance with a conventional technique. Referring to FIG. 4, there are shown a Y discharge sustaining electrode drive circuit 28 and an X discharge sustaining electrode drive circuit 30 in the conventional technique. During an address drive period, a scan driver IC 29 shown in FIG. 4 performs scanning per line. In selected-line driving, a low-voltage output switch circuit SCL is put in a conducting state, and a high-voltage output switch circuit SCH is put in a nonconducting state. In nonselected-line driving, the low-voltage output switch circuit SCL is put in nonconducting state, and the high-voltage output switch circuit SCH is put in a conducting state. During a discharge sustaining period, in the scan driver IC 29, the low-voltage output switch circuit SCL is put in a conducting state, and the high-voltage output switch circuit SCH is put in a nonconducting state. It is to be noted that, in the actual component arrangement according to the conventional technique, one Y discharge sustaining electrode drive circuit 28 and one X discharge sustaining electrode drive circuit 30 are disposed for one plasma panel 31, and one scan driver IC 29 is disposed for plural Y electrodes so that plural switch circuits thereof are operated to drive respective Y electrodes. In FIG. 4, there is shown a simplified arrangement illustration in which only one of plural output lines of the scan driver IC 29 is indicated similarly to FIG. 2 for the sake of clarity and convenience in explanation. Referring to FIG. 4, in the Y discharge sustaining electrode drive circuit 28, a voltage transition is made to a level proximate to +Vs/−Vs voltage by using an inductor Ly, a switch circuit S1y, and a switch circuit S2y for recovering charge in a capacitor Cxy. Then, for a potential not recovered through power recovery operation, a clamping is performed to each of +Vs voltage and −Vs voltage by using the switch circuit S3y and the switch circuit S4y, respectively. Likewise, in the X discharge sustaining electrode drive circuit 30, a voltage transition is made to a level proximate to +Vs/−Vs voltage by using an inductor Lx, a switch circuit S1x, and a switch circuit S2x for recovering charge in the capacitor Cxy. Then, for a potential not recovered through power recovery operation, a clamping is performed to each of +Vs voltage and −Vs voltage by using the switch circuit S3x and the switch circuit S4x, respectively.

As mentioned above, in the conventional technique, power recovery is carried out through use of the scan driver IC 29 during the discharge sustaining period. Consequently, the scan driver IC 29 acts as a resistance drive load at the time of power recovery, giving rise to a problem in that the efficiency of power recovery cannot be increased sufficiently.

With reference to FIG. 1, the following describes the details of drive circuit operation to be performed during the discharge sustaining period according to the first preferred embodiment of the present invention. In FIG. 1, reference numerals 28 and 30 indicate the Y discharge sustaining electrode drive circuit and the X discharge sustaining electrode drive circuit in the first preferred embodiment of the present invention, respectively. During the address drive period, the scan driver IC 29 shown in FIG. 1 performs scanning per line. In selected-line driving, a low-voltage output switch circuit SCL is put in a conducting state, and a high-voltage output switch circuit SCH is put in a nonconducting state. In a nonselected-line driving, the low-voltage output switch circuit SCL is put in a nonconducting state, and the high-voltage output switch circuit SCH is put in a conducting state. During the discharge sustaining period, in the scan driver IC 29, the low-voltage output switch circuit SCL is put in a conducting state and the high-voltage output switch circuit SCH is put in a nonconducting state at the time of power recovery on the Y electrode and at the time of clamping to −Vs thereon. Contrastingly, at the time of clamping to +Vs on the Y electrode, the low-voltage output switch circuit SCL is put in a nonconducting state and the high-voltage output switch circuit SCH is put in a conducting state. It is to be noted that, in the actual component arrangement according to the preferred embodiment, one Y discharge sustaining electrode drive circuit 28 and one X discharge sustaining electrode drive circuit 30 are disposed for one plasma panel 31, and one scan driver IC 29 is disposed for plural Y electrodes so that plural switch circuits thereof are operated to drive respective Y electrodes. In FIG. 1, there is shown a simplified arrangement illustration in which only one of plural output lines of the scan driver IC 29 is indicated similarly to FIG. 2 for the sake of clarity and convenience in explanation.

With reference to FIGS. 1 and 3, the following describes the details of control signal timing in drive circuit operation to be performed according to the first preferred embodiment of the present invention. In FIG. 3, there is shown a timing sequence of control signals in conducting/nonconducting operation of respective switch circuits indicated in FIG. 1. The high level of each control signal represents a conducting state (ON state), and the low level thereof represents a nonconducting state (OFF state). In timing operation for the Y electrode in FIG. 3, when a signal S1y goes ON, a voltage transition is made on the Y electrode from −Vs voltage to a level proximate to +Vs voltage through resonance. Then, a signal SCH goes ON to perform a clamping to +Vs voltage from the level proximate thereto. Thereafter, when a signal SCL goes ON, a voltage transition is made on the Y electrode from +Vs voltage to a level proximate to −Vs through resonance. Then, a signal S4y goes ON to perform a clamping to −Vs voltage from the level proximate thereto. In timing operation for the X electrode in FIG. 3, when a signal S1x goes ON, a voltage transition is made on the X electrode from −Vs voltage to a level proximate to +Vs voltage through resonance. Then, a signal S3x goes ON to perform a clamping to +Vs voltage from the level proximate thereto. Thereafter, when a signal S2x goes ON, a voltage transition is made on the X electrode from +Vs to a level proximate to −Vs through resonance. Then, a signal S4x goes ON to perform a clamping to −Vs from the level proximate thereto. For carrying out the timing sequence mentioned above in the first preferred embodiment of the present invention, there is provided a two-circuit configuration comprising SCL and S1y circuits used as a power recovery path switch circuit and a diode circuit. In comparison with a three-circuit configuration comprising SCL, S1y and D3y circuits or SCL, S2y and D4y circuits in the conventional technique, the number of component parts can be reduced according to the first preferred embodiment of the present invention.

In the above-described arrangement in which the scan driver IC 29 is used for power recovery operation during the discharge sustaining period, the number of component parts required for power recovery path circuitry is smaller than that in the conventional arrangement, leading to a decrease in resistance load. The efficiency of power recovery can thus be increased satisfactorily according to the first preferred embodiment of the present invention.

### Second Embodiment

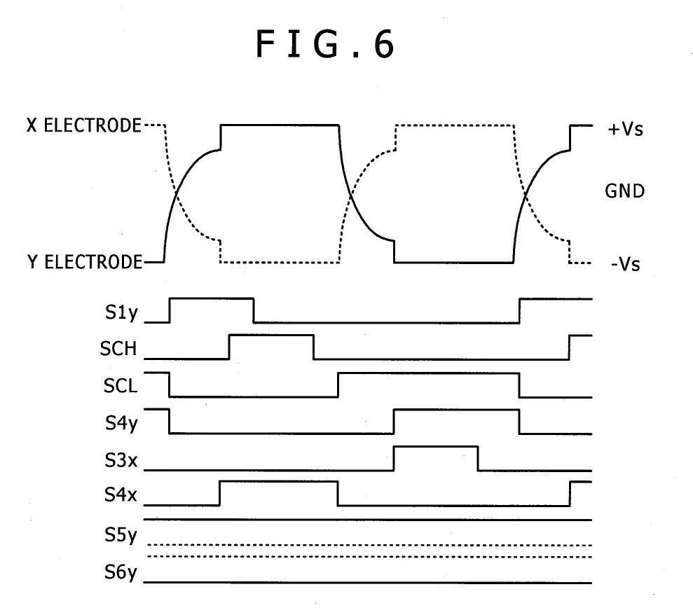

Referring to FIGS. 5 and 6, a second preferred embodiment of the present invention is described below. The configuration of plasma panel drive circuitry in the second preferred embodiment of the present invention is the same as that shown in FIG. 2 according to the first preferred embodiment thereof. In the second preferred embodiment of the present invention, power recovery operation through resonance in each of the discharge sustaining electrode drive circuit 28 and the X discharge sustaining electrode drive circuit 30 is carried out in a manner different from that in the first preferred embodiment of the present invention. With reference to FIGS. 5 and 6, the following describes the details of drive circuit operation to be performed according to the second preferred embodiment of the present invention. FIG. 5 shows a component arrangement of a power recovery circuit/discharge sustaining electrode drive circuit of a plasma display device, and FIG. 6 shows drive voltage waveforms in power recovery operation and discharge sustaining operation in a timing sequence of control signals of the drive circuitry thereof. In the second preferred embodiment of the present invention, although the operation of the scan driver IC 29 at the time of address driving is performed in the same manner as that in the first preferred embodiment of the present invention, a charge transition in the capacitor Cxy is effected on the Y and X electrodes simultaneously through resonance unlike the first preferred embodiment of the present invention.

In FIG. 6, there is shown a timing sequence of control signals in conducting/nonconducting operation of respective switch circuits indicated in FIG. 5. The high level of each control signal represents a conducting state (ON state), and the low level thereof represents a nonconducting state (OFF state). In timing operation shown in FIG. 6, when a signal S1y goes ON, a voltage transition on the Y electrode is made from −Vs voltage to a level proximate to +Vs voltage through resonance, and simultaneously a voltage transition on the X electrode is made from +Vs voltage to a level proximate to −Vs through resonance. Then, a signal SCH goes ON to perform a clamping on the Y electrode to +Vs voltage from the level proximate thereto, and a signal S4x goes ON to perform a clamping on the X electrode to −Vs voltage from the level proximate thereto. Thereafter, when a signal SCL goes ON, a voltage transition on the Y electrode is made from +Vs to a level proximate to −Vs through resonance, and simultaneously a voltage transition on the X electrode is made from −Vs voltage to a level proximate to +Vs through resonance. Then, a signal S4y goes ON to perform a clamping on the Y electrode to −Vs from the level proximate thereto, and a signal S3x goes ON to perform a clamping on the X electrode to +VS voltage from the level proximate thereto.

For carrying out the timing sequence mentioned above in the second preferred embodiment of the present invention, there is provided a two-circuit configuration comprising SCL and S1y circuits used as a power recovery path switch circuit and a diode circuit. In comparison with the three-circuit configuration comprising SCL, S1y and D3y circuits or SCL, S2y and D4y circuits in the conventional technique, the number of component parts can be reduced according to the second preferred embodiment of the present invention.

In the above-described arrangement in which the scan driver IC 29 is used for power recovery operation during the discharge sustaining period, the number of component parts required for power recovery path circuitry is smaller than that in the conventional arrangement, leading to a decrease in resistance load. The efficiency of power recovery can thus be increased satisfactorily according to the second preferred embodiment of the present invention.

### Third Embodiment

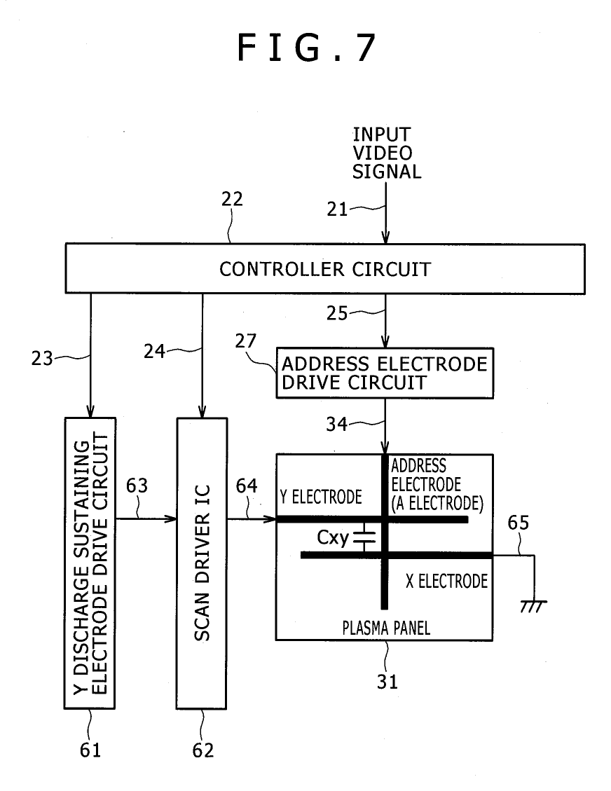

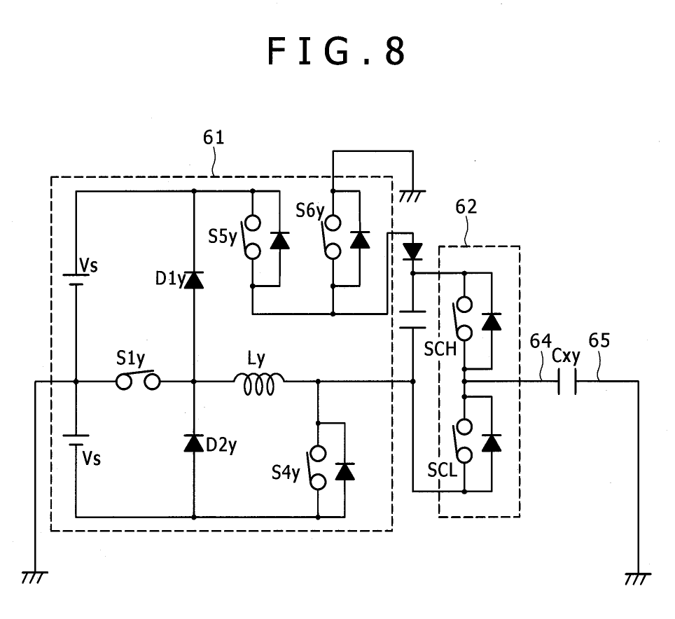

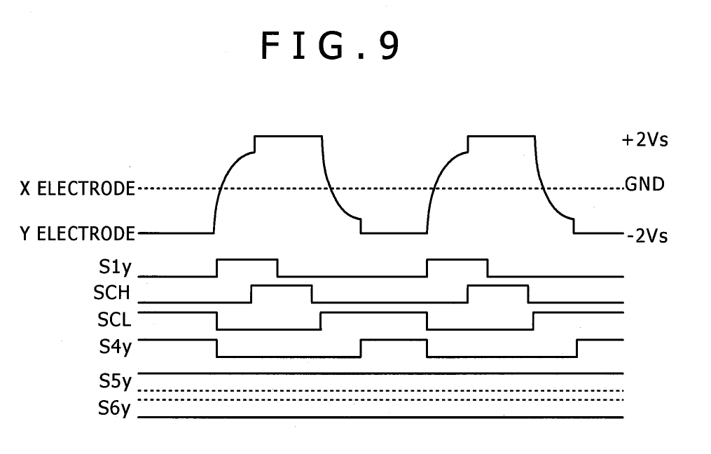

Referring to FIGS. 7, 8, and 9, a third preferred embodiment of the present invention is described below. The configuration of plasma panel drive circuitry shown in FIG. 7 according to the third preferred embodiment of the present invention differs from that of the first preferred embodiment of the present invention with respect to the following aspects. In the third preferred embodiment of the present invention, with the X electrode fixed to ground voltage level, 2Vs voltage is applied between the Y and X electrodes. Thus, the Y electrode is driven by using +2Vs voltage and −2Vs voltage. Power recovery in Y discharge sustaining electrode drive circuit operation is carried out differently from that of the first preferred embodiment of the present invention. In the configuration of plasma panel drive circuitry shown in FIG. 7, reference numeral 61 indicates a Y discharge sustaining electrode drive circuit, reference numeral 62 indicates a scan driver IC, and reference numeral 63 indicates a drive voltage output from the Y discharge sustaining electrode drive circuit 61 to the scan driver IC 62. Reference numeral 64 indicates a drive voltage output from the scan driver IC 62 for driving the Y electrode of the plasma panel 31. Reference numeral 65 indicates a drive voltage for fixing the X electrode of the plasma panel 31 to ground voltage level. FIG. 8 shows a component arrangement of a power recovery circuit/discharge sustaining electrode drive circuit of a plasma display device, and FIG. 9 shows drive voltage waveforms in power recovery operation and discharge sustaining operation in a timing sequence of control signals of the drive circuitry thereof. In the third preferred embodiment of the present invention, although the operation of the scan driver IC 62 at the time of address driving is performed in the same manner as that in the first preferred embodiment of the present invention, the Y electrode is driven with the X electrode fixed to ground voltage level.

In FIG. 9, there is shown a timing sequence of control signals in conducting/nonconducting operation of respective switch circuits indicated in FIG. 8. The high level of each control signal represents a conducting state (ON state), and the low level thereof represents a nonconducting state (OFF state). In timing operation shown in FIG. 9, the X electrode is fixed to ground voltage level, and when a signal S1y goes ON, a voltage transition is made on the Y electrode from −2Vs to a level proximate to +2Vs through resonance. Then, a signal SCH goes ON to perform a clamping on the Y electrode to +2Vs from the level proximate thereto. Thereafter, when a signal SCL goes ON, a voltage transition is made on the Y electrode from +2Vs to a level proximate to −2Vs through resonance. Then, a signal S4y goes ON to perform a clamping to −2Vs from the level proximate thereto.

For carrying out the timing sequence mentioned above in the third preferred embodiment of the present invention, there is provided a two-circuit configuration including SCL and S1y circuits used as a power recovery path switch circuit and a diode circuit. In comparison with the three-circuit configuration comprising SCL, S1y and D3y circuits or SCL, S2y and D4y circuits in the conventional technique, the number of component parts can be reduced according to the third preferred embodiment of the present invention.

In the above-described arrangement in which the scan driver IC 62 is used for power recovery operation during the discharge sustaining period, the number of component parts required for power recovery path circuitry is smaller than that in the conventional arrangement, leading to a decrease in resistance load. The efficiency of power recovery can thus be increased satisfactorily according to the third preferred embodiment of the present invention.

The present invention may be embodied in other specific forms without departing from the spirit or essential characteristics thereof. The preferred embodiments described herein are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A matrix display device in which a plurality of address electrodes are driven per line by a scan drive circuit to control a display state of each display pixel on the basis of display data, and in which, during a luminescence emission period, a discharge is effected for display by applying an alternating voltage between each of a plurality of first discharge sustaining electrodes and each of a plurality of second discharge sustaining electrodes with a capacitance load corresponding to each display pixel, the matrix display device comprising:
a first discharge sustaining electrode drive circuit; and
a second discharge sustaining electrode drive circuit;
wherein, in electrode driving operation for driving the first discharge sustaining electrode and the second discharge sustaining electrode with the alternating voltage, the first discharge sustaining electrode drive circuit and the second discharge sustaining electrode drive circuit perform power recovery for the capacitance load through an LC resonance circuit using an inductor, and
wherein, in address scanning operation, the scan drive circuit selects the first discharge sustaining electrode per line, and in discharge sustaining operation, the scan drive circuit serves to provide a function of the first discharge sustaining electrode drive circuit for recovering power on the first discharge sustaining electrode.

2. The matrix display device according to claim 1,
wherein the scan drive circuit comprises a high-voltage output switch circuit and a low-voltage output switch circuit,
wherein, in address scanning operation, the high-voltage output switch circuit applies a high voltage for non-selection to a non-selected line, and the low-voltage output switch circuit applies a low voltage for selection to a selected line, and
wherein, in discharge sustaining operation, the high-voltage output switch circuit performs a clamp-up operation for power recovery, and the low-voltage output switch circuit performs a recovery switching operation for power recovery.

3. The matrix display device according to claim 1,
wherein, in discharge sustaining operation, the alternating voltage is applied so as to provide a repeated waveform cycle in which the first discharge sustaining electrode and the second discharge sustaining electrode are set to a low voltage level once at the same point of time, then the first discharge sustaining electrode is set to a high voltage level while the second discharge sustaining electrode is retained at the low voltage level, then the first discharge sustaining electrode is set to the low voltage level while the second discharge sustaining electrode is retained at the low voltage level, then the first discharge sustaining electrode is retained at the low voltage level while the second discharge sustaining electrode is set to the high voltage level, and then the first discharge sustaining electrode is retained at the low voltage level while the second discharge sustaining electrode is set to the low voltage level.

4. The matrix display device according to claim 1,
wherein, in discharge sustaining operation, the alternating voltage is applied so as to provide a repeated waveform cycle in which the first discharge sustaining electrode is set at a high voltage level while the second discharge sustaining electrode is set at a low voltage level, then the first discharge sustaining electrode and the second discharge sustaining electrode are set to the low voltage level and the high voltage level respectively through simultaneous voltage transition thereof, then the first discharge sustaining electrode is retained at the low voltage level while the second discharge sustaining electrode is retained at the high voltage level, then the first discharge sustaining electrode and the second discharge sustaining electrode are set to the high voltage level and the low voltage level respectively through simultaneous voltage transition thereof, and then the first discharge sustaining electrode is retained at the high voltage level while the second discharge sustaining electrode is retained at the low voltage level.

5. The matrix display device according to claim 1,
wherein, in discharge sustaining operation, the alternating voltage is applied so as to provide a repeated waveform cycle in which, with the second discharge sustaining electrode fixed at an intermediate potential between a high voltage level and a low voltage level for alternating drive on the first discharge sustaining electrode, the first discharge sustaining electrode is retained at the low voltage level, then the first discharge sustaining electrode is set to the high voltage level through voltage transition thereof, then the first discharge sustaining electrode is retained at the high voltage level, then the first discharge sustaining electrode is set to the low voltage through voltage transition thereof, and then the first discharge sustaining electrode is retained at the low voltage level.
